(19) United States
(12) Patent Application Publication
(10) Pub. No.: US 2004/0007693 A1
(43) Pub. Date: Jan. 15, 2004

(54) Ionic liquids containing borate or phosphate anions

(76) Inventor: Roger Moulton, Austin, TX (US)

Correspondence Address: Gregory L. Porter, VINSON & ELKINS LLP, 2300 First City Tower, 1001 Fannin, Houston, TX, 77002-6760, US

(21) Appl. No.: 10/188,452

(22) Filed: Jul. 3, 2002

(51) Int. Cl. C07F 5/02; C07F 9/02; C23G 5/00; B01F 1/00

(52) U.S. Cl. 252/364; 546/13; 546/22; 568/1; 568/9

(57) ABSTRACT

The present invention relates to novel ionic liquids comprising a phosphate or borate anion. The ionic liquids may be made via metathesis or via a reaction between boric or phosphoric acid with metal hydroxide and an alcohol.

### FIELD OF THE INVENTION

The present invention pertains to compositions comprising an ionic liquid comprising an anion of phosphate or borate, and processes for making said compositions.

### BACKGROUND AND SUMMARY OF THE INVENTION

Ionic liquids are salts that are liquid at ambient or near ambient temperatures. Ionic liquids have a number of uses which include replacing organic solvents in chemical processes and reactions, extracting organic compounds from aqueous waste streams, and as electrolytes in devices such as capacitors and batteries. This is because, unlike conventional organic solvents, ionic liquids are non-volatile and non-flammable. These properties are advantageous to help reduce losses to evaporation, eliminate volatile organic emissions, and improve safety.

Other properties of ionic liquids have also proved advantageous. For example, many ionic liquids have a broad temperature range at which they remain liquid and also are stable over a broad pH range. This is beneficial for high temperature processes with a demanding pH. Further, some ionic liquid systems can be used as both a solvent and catalyst. For example, [bmim]-Al₂Cl₇ and [emim]-Al₂Cl₇ can be employed as a solvent and catalyst in Friedel-Crafts reactions wherein bmim is 1-butyl-3methylimidazolium and emim is 1-ethyl-3-methylimidazolium.

For the aforementioned reasons, it would be desirable to discover new ionic liquid compounds with advantageous properties. It would further be desirable if such compounds could be made by simple processes with low amounts of waste and impurities.

Advantageously, new ionic liquid compounds have been discovered. The compounds comprise either a phosphate or borate anion and are made via simple processes which are capable of producing ionic liquids having a purity of 99% or higher.

### DETAILED DESCRIPTION OF THE INVENTION

As used herein “ionic liquid” means a salt comprising a cation and an anion. The salt (or hydrate or solvate of the salt) is a liquid at ambient or near ambient temperatures (.e.g. from about 0 to about 100° C.). An ionic liquid may comprise two or more different salts, e.g., mixtures of salts comprising two or more different cations, anions, or both. The ionic liquids of the present invention are often hydrated or solvated. Thus, both hydrates and solvates are considered to be within the definition of “ionic liquid.”

As used herein “hydrophilic ionic liquid” means an ionic liquid which is partially or wholly miscible with water.

As used herein “hydrophobic ionic liquid” means an ionic liquid which is relatively immiscible with water, i.e., forms two phases at ambient conditions.

As used herein “composition” includes a mixture of the materials that comprise the composition, as well as, products formed by the reaction or the decomposition of the materials that comprise the composition.

As used herein “derived from” means made or mixed from the specified materials, but not necessarily composed of a simple mixture of those materials. Substances “derived from” specified materials may be simple mixtures of the original materials, and may also include the reaction products of those materials, or may even be wholly composed of reaction or decomposition products of the original materials.

As used herein “halo” means chloro, bromo, flouro, or iodo, arylene means a divalent aromatic group such as phenylene, napthylenylene, biphenylene, antracenylene, phenanthrenylene, etc., heteroarylene means a divalent heteroaromatic group such as pyrrolene, furanylene, thiophenylene, pyridinylene, etc., alkylene means a divalent alkane group which may be substituted with one or more heteroatoms such as nitrogen or oxygen, alkenylene means a divalent alkene group which may be substituted with one or more heteroatoms such as nitrogen or oxygen.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 and the like, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The ionic liquid of the present invention comprise one or more compounds. Thus, the ionic liquid may be a pure compound or may be a mixture of compounds. Each compound comprises an anion and a cation as described below.

Anions

The anions of compounds of the instant invention include those having the chemical structure I.

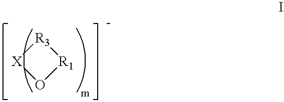

In chemical structure I, X is selected from the group consisting of IIIA elements such as boron and Group VA elements such as phosphorus and arsenic. If X is a Group IIIA element then the anion has two ligands and m is two (2) whereas if X is a Group VA element then the anion has three ligands and m is three (3). Preferably X is either boron (B) or phosphorus (P) and more preferably X is boron. When X is B then m is 2. When X is phosphorus (P) then m is 3. In chemical structure I, R₁ is independently selected from the group consisting of substituted or unsubstituted alkylene, alkenylene, arylene, heteroarylene, —C(O)—R₂—, and —C(O)—R₂—C(O)— and R₂ is independently selected from the group consisting of substituted or unsubstituted alkylene, alkenylene, arylene, and heteroarylene and R₃ is independently selected from O or S. Since R₁ and R₂ may be independently selected, bidentate anions may have two different ligands and tridentate ligands may have three different ligands.

R₁ and R₂ may optionally be substituted with one or more substituents. The type of the substituent is not particularly critical so long as the compound or mixture of compounds is a liquid at ambient or near ambient temperatures. Thus, the substituents usually include typical and non-typical organic subsitituents such as those selected from the group consisting of alkyl, alkoxy, alkylthio, SO₃H, NO₂, halo, cyano, silyl, OH, and other suitable substituents. The substituent group itself may often be further substituted.

A particularly preferred class of substitutents on R₁ and R₂—particularly when R₁ or R₂ is arylene or heteroarylene—are electron-withdrawing groups such as halo or nitro. Also, in some instances, two or more adjacent substitutents on an arylene or an heteroarylene group may be taken together to form a ring such as a 5-7 membered carbocyclic or heterocyclic ring. Examples of such carbocyclic rings include cyclopentyl and cyclohexyl rings while examples of such heterocyclic rings include morpholino and piperidino rings.

Preferred anions include those anions in which R₁ is independently selected from substituted or unsubstituted cyclohexylene, phenylene, naphthalenylene, biphenylene, —C(O)— phenylene-C(O)—, or pyridinylene.

Particularly preferred anions include those anions having structures II-VIII below.

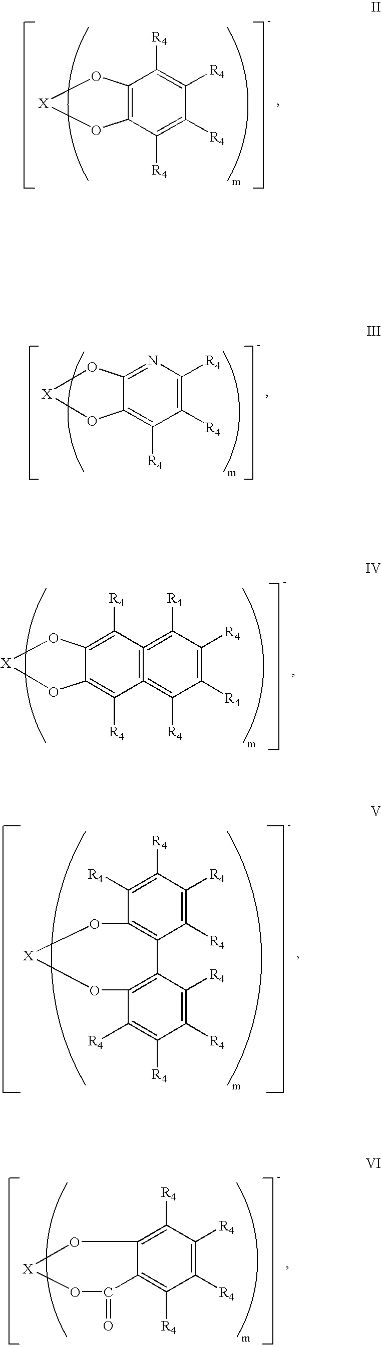

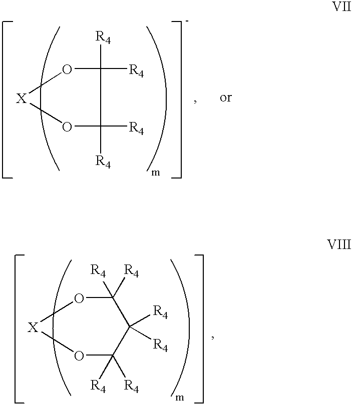

In structures II-VIII, X, m, R₂, and R₃ are as previously described and R₄ is selected from H, alkyl, alkoxy, alkylthio, SO₃H, NO₂, halo, cyano, silyl, OH, and other suitable substituents. For all of the anions previously described, X is preferably boron.

Cations

The cation of the ionic liquid to be produced is not particularly critical so long as the ionic liquid has properties to make it suitable for its intended use. Typical useful cations include, for example, “onium” cations. Onium cations include cations such as substituted or unsubstituted ammonium, phosphonium, and sulfonium cations. Preferred onium cations include, for example, substituted or unsubstituted N-alykl or N-aryl pyridinium, pyridazinium, pyrimidinium, pyrazinium, imidazolium, pyrazolium, thiazolium, oxazolium, triazolium, imidazolinium, methylpyrrolidinium, isothiazolium, isoxazolium, oxazolium, pyrrolium, and thiophenium. The substituents include one or more of the following groups: halo, alkyl, and aryl groups such as phenyl. In addition, two adjacent substituents may be joined together to form an alkylene radical thereby forming a ring structure converging on N. The alkyl, phenyl, and alkylene radicals may be further substituted. Another particularly preferred cation is an ammonium cation substituted by one or more groups such as alkyl and aryl groups such as phenyl. Many such cations and substituted cations are described in U.S. Pat. Nos. 5,827,602 and 5,965,054 which are incorporated by reference in their entirety.

Processes to make Compounds Having Structures I-VIII and Mixtures Thereof

The ionic liquid compounds of structures II-VIIII may be conveniently made by a number of different processes. One process which is suitable for making hydrophobic or hydrophilic ionic liquids or mixtures of the present invention comprises:

contacting Q-OH and H—R₃—R₁—OH with OH—R₅ under conditions sufficient to form a desired ionic liquid and water,

wherein Q is a quaternary ammonium or phosphonium cation;

wherein R₅ is —B(OH)₂ or —P(O)(OH)₂; and wherein R₁, R₂, and R₃ are as described above for structure I.

The manner of contacting Q-OH, H—R₃—R₁—OH, and OH—R₅ is not particularly important so long as the desired reaction occurs. Generally, the three or more compounds can be mixed in any order, can be formed in situ, or can be mixed together with a solvent such as water which is at least partially miscible and does not significantly react with any of the compounds.

The starting compounds are often readily available and, in addition, many syntheses are available to those skilled in the art to make the desired starting compounds. For example, if onium hydroxide is to be employed as Q-OH, then suitable syntheses are described in, for example, U.S. Pat. Nos. 4,714,530; 5,853,555; 5,968,338; and 5,951,845 which are incorporated by reference in their entirety. Similarly, compounds having the formula H—R₃—R₁—OH can simply be bought or can be synthesized by, for example, substituting an OH group at the desired position on the compound H—R₃—R₆ wherein R₃ is as described above and R₆ is independently selected from the group consisting of substituted or unsubstituted alkyl, alkenyl, aryl, heteroaryl, —C(O)—R₂—H, —C(O)—R₂—CHO and —C(O)—R₂—CO₂H wherein R₂ is as described above.

The mixing conditions may vary depending on the specific compounds employed and the desired product. In most instances, it is acceptable to contact the compounds and the optional solvent at ambient pressure and a temperature high enough for the reaction to occur efficiently but not so high as to decompose or boil off any starting compound. Generally, the contacting temperature may range from about 75 to about 110° C., preferably from about 85 to about 100° C.

The manner in which the increased temperature is achieved and maintained is not particularly critical. Often any heating element may be employed as the compounds are mixed or the starting compounds can be heated separately and then mixed. Similarly, any vessel or reactor can be employed so long as it is of adequate size and material. Often it is beneficial to employ a stirring means to facilitate the reaction.

Generally, the increased temperature is maintained for at least a sufficient time until the desired reaction has occurred to the desired extent. In some instances, it may be desirable to maintain the increased temperature for a longer time than it takes to complete the reaction. In this manner, any water or lower boiling components that are formed as byproducts or present as solvents can be removed by boiling.

The amount of each of the at least three starting compounds may vary depending upon the desired yield. In general, high yields are often obtained by using about the stoichiometric amount of reactants, i.e., about a 1:1:2 ratio of Q-OH:H—R₃—R₁—OH:OH—R₅. However, as one skilled in the art will appreciate, different reaction conditions may alter the ratio of reactants at which the optimum yield occurs. Therefore, typical ratios may often include mole ratios of about 0.8-1.2:0.8-1.2:1.6-3.4 of Q-OH:H—R₃—R₁—OH:OH—R₅.

If one desires to make an ionic liquid mixture comprising two or more different salts or an anion having different ligands, then it is readily accomplished by employing a mixture of two or more different Q-OH compounds, two or more H—R₃—R₁—OH compounds, and/or two or more OH—R₅ compounds. The resulting ionic liquid salt mixture can then be used as a mixture or, if desired, individual salts can be separated by routine means.

If necessary, the ionic liquid or ionic liquid mixture may be recovered from the solvent and/or reaction mixture by any suitable means the most efficient of which may vary depending upon the type and desired purity of the ionic liquid or mixture. Preferable means of recovery include rotary evaporation or distillation, azeotropic distillation, ion chromatography, liquid liquid extraction, crystallization, pervaporization, drying agents, and reverse osmosis.

A second process which is suitable for making hydrophobic or hydrophilic ionic liquids or mixtures of the present invention comprises:

(1) contacting boric acid, phosphoric acid or a mixture thereof with a metal hydroxide and H—R₃—R₁—OH under conditions sufficient to form a metal salt comprising an anion having the structure I,

wherein X, R1, and R3 are as previously described; and (2) contacting the metal

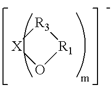

salt with Q-X; wherein Q is a quaternary ammonium or phosphonium ion and X is a halide, to form an ionic liquid.

Yet another process for making ionic liquids of the present invention which have an anion of structure I comprises mixing

(1) boric acid, phosphoric acid or a mixture thereof;

(2) a metal hydroxide;

(3) H—R₃—R₁—OH; and

(4) Q-X; wherein X, R₁, and R₃ are as previously described, Q is a quaternary ammonium or phosphonium ion, and X is a halide, and wherein the mixing conditions are sufficient to form an ionic liquid, or hydrate or solvate thereof. The mixing conditions for the above processes often comprise similar mixing conditions and reactant ratios as described above.

While the aforementioned processes may be employed to make hydrophobic or hydrophilic ionic liquids, they are particularly preferable to make hydrophobic ionic liquids. This is because hydrophobic ionic liquids are often not very soluble in the metal halide byproduct. Therefore, simple liquid-liquid extraction can be used to separate the hydrophobic ionic liquid from the metal halide byproduct. In contrast, hydrophilic ionic liquids are often not too miscible with the metal halide byproduct. Consequently, a different separation method, e.g., solvent extraction, can be employed. For example, it may be desirable or necessary to use a hydrophobic solvent like an alkyl chloride, e.g. methylene chloride, to extract the ionic liquid.

Characteristics and Uses of Ionic Liquids of the Present Invention

The purity of ionic liquids produced by the processes of this invention can often be greater than 95, preferably greater than 99, more preferably greater than 99.9%, most preferably greater than 99.99%. This is advantageous for processes which require high purity materials such as in the electronics industry.

The ionic liquids of the present invention are also useful in processes, for example, which require a task specific anion, cations, or combination thereof. For example, the ionic liquids may be useful in environmental processes in order to act as scavengers for toxic metals, catalytic poisons, or gases like CO₂ or NH₃. In such processes the substance to be scavenged is often contacted with the ionic liquid for a sufficient time to form a complex which is readily removable and/or disposable. Such processes may include employing an ammonium cation from an ionic liquid of the present invention to scavenge CO₂ or employing a sulfur-containing ionic liquid to complex with a heavy metal such as mercury or lead.

The following examples are not intended to limit the invention, but rather, are intended only to illustrate a few specific ways the instant invention may be employed.

### EXAMPLE 1

Synthesis of 1-butyl-3-methylimidazolium bis(3-methylsalicyl)borate

1 mole of Lithium hydroxide, 1 mole of boric acid and 2 moles of 3-methylsalicylic acid were mixed in 200 ml water and heated to boiling, whereupon a homogenous solution was obtained, and everything dissolved. After 15 minutes, it was cooled to room temperature and a lot of white solid began to precipitate. The supernatant solution was brownish and was decanted. The yield of the lithium bis(3-methylsalicyl)borate was 70%.

The Lithium bis(3-methylsalicyl)borate was dissolved in 500 ml water and 1 mole of 1-butyl-3-methyl imidazolium chloride was added as a 85% solution in water. The mixture was stirred and heated gently for 15 minutes, then allowed to cool and settle. Two layers formed, which were separated in a separatory funnel. The hydrophobic ionic liquid lower layer was collected, washed with water at 70 C., and was isolated in 50% yield. The hydrated ionic liquid was a thick hydrophobic ionic liquid at room temperature which was stable towards loss of water.

### EXAMPLE 2

Synthesis of methyltributylammonioum bis(catechol)borate

1 mole of Lithium hydroxide, 1 mole of boric acid and 2 moles of catechol were mixed in 200 ml water and heated to boiling, whereupon a homogenous solution was obtained, and everything dissolved. After 15 minutes, it was cooled to room temperature and a lot of white solid began to precipitate. The supernatant solution was reddish and was decanted. The yield of the lithium bis(catechol)borate was 70%.

The Lithium bis(catechol)borate was dissolved in 500 ml water and 1 mole of methyltributylammonium chloride was added as a 55% solution in water. The mixture was stirred and heated to near boiling for 15 minutes, then allowed to cool and settle. Two layers formed, and the lower layer froze upon cooling. The lower hydrophobic ionic liquid layer was collected by decanting, washed with water at 90 C., and then isolated by drying in 50% yield. It was a solid at room temperature with a melting point of 77 C. Its hydrate was unstable towards loss of water at 4° C.

### EXAMPLE 3

Synthesis of methyltriethylammonium bis(salicyl)borate

1 mole of Lithium hydroxide, 1 mole of boric acid and 2 moles of salicylic acid were mixed in 200 ml water and heated to boiling, whereupon a homogenous solution was obtained, and everything dissolved. After 15 minutes, it was cooled to room temperature and a lot of white solid began to precipitate. The supernatant solution was brownish and was decanted. The yield of the lithium bis(salicyl)borate was 70%.

The Lithium bis(salicyl)borate was dissolved in 500 ml water and 1 mole of metyltriethylammonium chloride was added as a 55% solution in water. The mixture was stirred and heated to near boiling for 15 minutes, then was cooled to 4° C. and settled. Two layers had formed, and the lower layer remained liquid upon cooling. The lower hydrophobic ionic liquid layer was collected by decanting, and washed with water at 90° C., and then isolated in 50% yield. It remained a liquid while in contact with water to 4° C. or lower. However when the water was removed in vacuo, or upon standing for extended period, a higher melting point solid (m.p. >100 C.) was obtained. Its hydrate was unstable towards loss of water at 4° C.

### EXAMPLE 4

Synthesis of 1-butyl-3-methylimidazolium bis(salicyl)borate

1 mole of Lithium hydroxide, 1 mole of boric acid and 2 moles of salicylic acid were mixed in 200 ml water and heated to boiling, whereupon a homogenous solution was obtained, and everything dissolved. After 15 minutes, it was cooled to room temperature and a lot of white solid began to precipitate. The supernatant solution was brownish and was decanted. The yield of the lithium bis(salicyl)borate was 80%.

The Lithium bis(salicyl)borate was dissolved in 500 ml water and 1 mole of 1-butyl-3-methyl imidazolium chloride was added as a 85% solution in water. The mixture was stirred and heated gently for 15 minutes, then allowed to cool and settle. Two layers quickly formed, which were separated in a separatory funnel. The lower layer was collected, washed with water at 70° C., and was isolated in 80% yield. It remained solid to 4° C. and did not precipitate any solids. Residual water in the ionic liquid was removed by heating to 130° C., and upon cooling the liquid became viscous, but did not solidify. The addition of water restored its original low viscosity.

### EXAMPLES 5-18

The hydrophobic ionic liquids of Examples 5-18 in Table 1 below were made substantially as in the same manner as Examples 1-4 except that acids which corresponded to the desired anion were employed and ammonium chlorides that corresponded to the desired anion were employed.

| Example | Cation | Anion | Properties |
|---|---|---|---|
| 5 | choline | bis(3methylsalicyl)borate | solid melting point |
| | | | >25° C., hydrate |
| | | | loses water at 4° C. |
| 6 | BMIM | bis(4-hydroxysalicyl)borate | hydrate is stable |
| | | | towards loss of H2O |
| 7 | Bu4N | bis(4-hydroxysalicyl)borate | solid melting point |
| | | | >25° C., hydrate |
| | | | loses water at 4° C. |
| 8 | OMIM | bis(salicyl)borate | hydrate stable to- |
| | | | wards loss of H2O |
| | | | and freezing at |
| | | | 40° C. |
| 9 | DDMIM | bis(salicyl)borate | hydrate stable to- |
| | | | wards loss of H2O |
| | | | and freezing at |
| | | | 4° C. |
| 10 | Et3PrN | bis(salicyl)borate | dried solid but |
| | | | hydrate unstable to- |
| | | | wards loss of H20 |
| | | | at 4° C. (2.32 |
| | | | moles H2O per |
| | | | mole product) |
| 11 | MeBu3N | bis(salicyl)borate | dried solid with |
| | | | melting point 63- |
| | | | 66° C. but hydrate |
| | | | unstable towards |
| | | | loss of H2O at 4° C. |
| | | | (1.76 moles H2O |
| | | | per mole product) |
| 12 | Bu4N | bis(salicyl)borate | dried solid with |
| | | | melting point |
| | | | >85° C. but |
| | | | hydrate unstable |
| | | | towards loss of |
| | | | H2O at 4° C. |
| 13 | MeEt3N | bis(catechol)borate | water soluble - no |
| | | | product |
| 14 | Et4N | bis(catechol)borate | dried solid with |
| | | | melting point 47- |
| | | | 48° C. but hydrate |
| | | | unstable towards |
| | | | loss of H2O at 4° C. |
| 15 | Bu4N | bis(catechol)borate | dried solid with |
| | | | melting point |
| | | | >85° C. |
| | | | but hydrate unstable |
| | | | towards loss of |
| | | | H2O at 4° C. |
| 16 | OMIM | bis(catechol)borate | dried solid with |
| | | | melting point 45° C. |
| | | | but hydrate unstable |
| | | | towards loss of |
| | | | H2O at 4° C. |
| 17 | BMIM | bis(catechol)borate | dried solid with |
| | | | melting point 40° C. |
| | | | but hydrate unstable |
| | | | towards loss of |
| | | | H2O at 4° C. |
| 18 | BMIM | bis(4-t-butylcatechol)borate | dried solid with |
| | | | melting point 53° C. |
| | | | but hydrate unstable |
| | | | towards loss of |
| | | | H2O at 4° C. |

BMIM = 1-butyl-3-methylimidazolium
OMIM = 1-octyl-3-methylimidazolium
DDMIM = 1-dodecyl-3-methylimidazolium

### EXAMPLE 19

Synthesis of tetraethylammonium bis(salicyl)borate

1 mole of tetraethylammonium hydroxide (35% in water), 1 mole of boric acid and 2 moles of salicylic acid were mixed in 200 ml water and heated to boiling. At 100° C. two liquid phases had formed after 15 minutes, then it was cooled to room temperature and allowed to settle. The lower layer was collected by decantation and washed with water, and then cooled to 4° C. overnight. The product was isolated in 80% yield. It remained a liquid while in contact with water, however when the water was removed a higher melting point solid (m.p. 117-119° C.) was obtained. The hydrate was unstable towards loss of water at 4° C.

### EXAMPLE 20

Synthesis of tetrabutyllammonium bis(2-thiobenzoyl)borate

1 mole of tetrabutylammonium hydroxide (35% in water), 1 mole of boric acid and 2 moles of 2-thiobenzoic acid were mixed in 200 ml water and heated to boiling. At 100° C. two liquid phases had formed (the bottom one yellow) after 15 minutes, it was cooled to room temperature and allowed to settle. The lower layer was collected by decantation and washed with water at 70° C., and then cooled and the bottom layer collected. The product was isolated in 100% yield. It remained a liquid even after the dissolved water was removed at 130° C. At 50° C. the dried ionic liquid of tetrabutyllammonium bis(2-thiobenzoyl)borate was quite fluid though at room temperature its viscosity was very high.

### EXAMPLE 21

Synthesis of choline bis(salicyl)borate

1 mole of choline hydroxide (35% in water), 1 mole of boric acid and 2 moles of salicylic acid were mixed in 200 ml water and heated to boiling. At 100° C. two liquid phases had formed after 15 minutes, it is cooled to room temperature and allowed to settle. The lower layer is collected by decantation and washed with water, and then cooled to 4° C. overnight. The product was isolated in 70% yield. It remained a highly fluid hydrophobic liquid while in contact with water, however when the water was removed (and when the solution was cooled to 4° C.) a higher melting point solid (needle crystals, m.p. >140° C.) was obtained.

### EXAMPLE 22

Synthesis of tetrapropylammonium bis(salicyl)borate

1 mole of tetrapropylammonium hydroxide, 1 mole of boric acid and 2 moles of salicylic acid were mixed in water and heated to boiling. The lower layer was collected by decantation and washed with water, and then cooled to 4° C. overnight. The product was isolated. It remained a liquid while in contact with water, however when the water was removed a higher melting point solid (m.p. >130° C.) was obtained. The hydrate was unstable towards loss of water at 4° C.

### EXAMPLE 23

Mixture of methyltriethylammonium bis(catechol)borate and 1-octyl-3-methylimidazolium bis(catechol)borate

A mixture of methyltriethylammonium bis(catechol)borate and 1-octyl-3-methylimidazolium bis(catechol)borate was made by mixing the pure substances.

### EXAMPLE 24

Mixture of methyltributylammonium bis(catechol)borate and 1-octyl-3-methylimidazolium bis(catechol)borate

A mixture of methyltributylammonium bis(catechol)borate and 1-octyl-3-methylimidazolium bis(catechol)borate was made by mixing the pure substances. The dried product had a melting point of >25° C.

### EXAMPLE 25

Mixture of 1-butyl-3-methylimidazolium bis(catechol)borate and 1-octyl-3-methylimidazolium bis(catechol)borate

A mixture of 1-butyl-3-methylimidazolium bis(catechol)borate and 1-octyl-3-methylimidazolium bis(catechol)borate was made by mixing the pure substances. The dried product had a melting point of 40° C.

What is claimed is:

1. An ionic liquid comprising an anion and a cation wherein the anion is 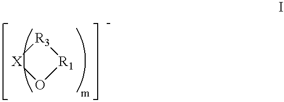
wherein X is B or P with the proviso
that when X is B, then m is 2 and
when X is P, then m is 3,
wherein R₁ is independently selected from the group consisting of substituted or unsubstituted alkylene, alkenylene, arylene, heteroarylene, —C(O)—R₂—, and —C(O)—R₂—C(O)—; and
wherein R₂ is independently selected from the group consisting of substituted or unsubstituted alkylene, alkenylene, arylene, and heteroarylene;
wherein R₃ is independently selected from O or S; and wherein
the cation is a quaternary ammonium or phosphonium cation, and hydrates and solvates of said ionic liquid.

2. The ionic liquid of claim 1 wherein R₁ is independently selected from substituted or unsubstituted cyclohexylene, phenylene, naphthalenylene, biphenylene, —C(O)-phenylene-C(O)—, or pyridinylene.

3. The ionic liquid of claim 1 wherein the anion is 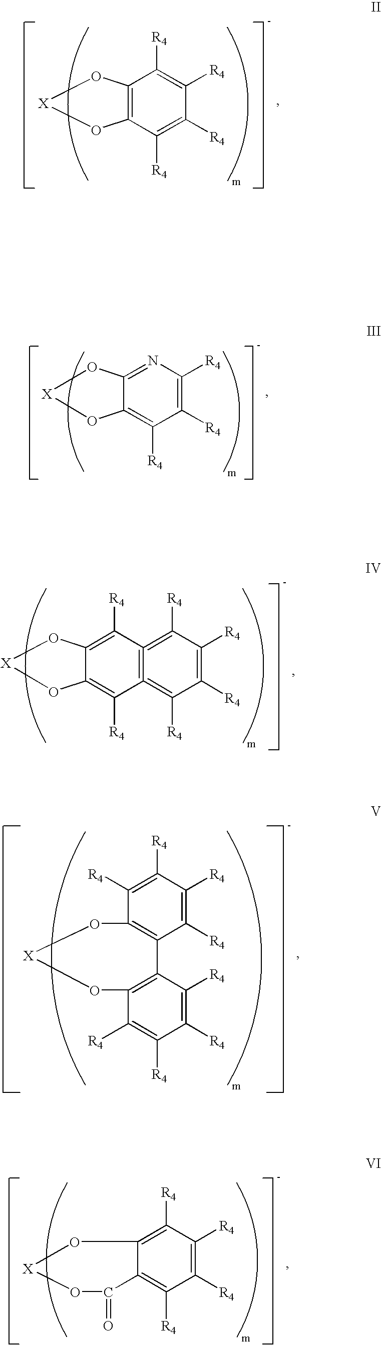 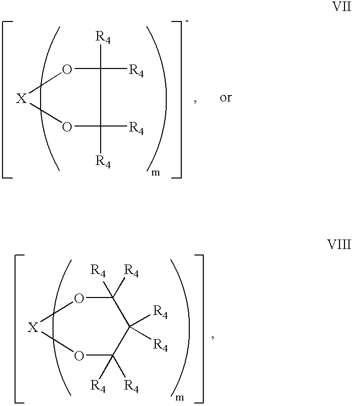
wherein X and R₃ are as described in claim 1; and wherein R₄ is selected from H, alkyl, alkoxy, alkylthio, SO₃H, NO₂, halo, cyano, silyl, OH, and suitable substituents.

4. The ionic liquid of claim 3 having the chemical structure II wherein X is B and m is 2.

5. The ionic liquid of claim 3 having the chemical structure II wherein X is P and m is 3.

6. The ionic liquid of claim 3 having the chemical structure III wherein X is B and m is 2.

7. The ionic liquid of claim 3 having the chemical structure III wherein X is P and m is 3.

8. The ionic liquid of claim 3 having the chemical structure IV wherein X is B and m is 2.

9. The ionic liquid of claim 3 having the chemical structure IV wherein X is P and m is 3.

10. The ionic liquid of claim 3 having the chemical structure V wherein X is B and m is 2.

11. The ionic liquid of claim 3 having the chemical structure V wherein X is P and m is 3.

12. The ionic liquid of claim 3 having the chemical structure VI wherein X is B and m is 2.

13. The ionic liquid of claim 3 having the chemical structure VI wherein X is P and m is 3.

14. The ionic liquid of claim 3 having the chemical structure VII wherein X is B and m is 2.

15. The ionic liquid of claim 3 having the chemical structure VII wherein X is P and m is 3.

16. The ionic liquid of claim 3 having the chemical structure VIII wherein X is B and m is 2.

17. The ionic liquid of claim 3 having the chemical structure VIII wherein X is P and m is 3.

18. The ionic liquid of claim 1 wherein the quaternary ammonium cation is independently selected from the group consisting of substituted or unsubstituted pyridinium, pyridazinium, pyrimidinium, pyrazinium, imidazolium, pyrazolium, thiazolium, oxazolium, triazolium, imidazolinium, methylpyrrolidinium, isothiazolium, isoxazolium, oxazolium, pyrrolium, and thiophenium.

19. The ionic liquid of claim 1 wherein the cation is an ammonium cation substituted by one or more groups selected from the group consisting of alkyl and aryl groups.

20. The ionic liquid of claim 18 wherein the quaternary ammonium cation is BMIM.

21. A process for making an ionic liquid or hydrate or solvate thereof wherein the ionic liquid comprises an anion and a cation wherein the anion is 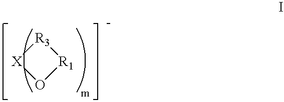
wherein X is B or P with the proviso that when X is B, then m is 2 and when X is P, then m is 3,
wherein R₁ is independently selected from the group consisting of substituted or unsubstituted alkylene, alkenylene, arylene, heteroarylene, —C(O)—R₂—, and —C(O)—R₂—C(O)—; and
wherein R₂ is independently selected from the group consisting of substituted or unsubstituted alkylene, alkenylene, arylene, and heteroarylene;
wherein R₃ is independently selected from O or S; and wherein
the cation is a quaternary ammonium or phosphonium cation.
wherein the process comprises:
contacting Q-OH and H—R₃—R₁—OH with OH—R₅ under conditions sufficient to form a desired ionic liquid and water,
wherein Q is a quaternary ammonium or phosphonium cation;
wherein R₅ is —B(OH)₂ or —P(O)(OH)₂; and wherein R₁, R₂, and R₃ are as described for I.

22. The process of claim 21 wherein the conditions comprise contacting Q-OH, H—R₃—R₁—OH, and OH—R₅ at a temperature of from about 75 to about 110° C.

23. The process of claim 22 wherein the temperature is maintained such that at least a portion of water in the reaction mixture is removed by boiling.

24. The process of claim 21 wherein two or more ionic liquids are formed.

25. The process of claim 24 which further comprises separating an ionic liquid from the two or more ionic liquids.

26. The process of claim 21 which further comprises separating the ionic liquid from the reaction mixture.

27. A process for making an ionic liquid comprising an anion and a cation wherein the anion is
wherein X is B or P with the proviso that when X is B, then m is 2 and when X is P, then m is 3, 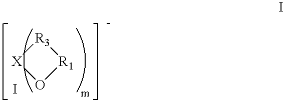
wherein R₁ is independently selected from the group consisting of substituted or unsubstituted alkylene, alkenylene, arylene, heteroarylene, —C(O)—R₂—, and —C(O)—R₂—C(O)—; and
wherein R₂ is independently selected from the group consisting of substituted or unsubstituted alkylene, alkenylene, arylene, and heteroarylene;
wherein R₃ is independently selected from O or S; and wherein
the cation is a quaternary ammonium or phosphonium cation;
wherein the process comprises:
mixing
(1) boric acid, phosphoric acid or a mixture thereof;
(2) a metal hydroxide;
(3) H—R₃—R₁—OH; and
(4) Q-X;
wherein X, R1, and R3 are as previously described, Q is a quaternary ammonium or phosphonium ion, and X is a halide, wherein the mixing conditions are sufficient to form an ionic liquid, or hydrate or solvate thereof.

28. The process of claim 27 which further comprises separating the ionic liquid, hydrate, or solvate thereof from any by-products.

29. The process of claim 28 wherein separating comprises adding a solvent to extract the ionic liquid.

30. The process of claim 29 wherein the solvent comprises alkyl chloride.

31. A process for making an ionic liquid comprising an anion and a cation wherein the anion is 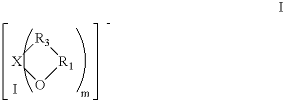
wherein X is B or P
with the proviso that
when X is B, then m is 2 and
when X is P, then m is 3,
wherein R₁ is independently selected from the group consisting of substituted or unsubstituted alkylene, alkenylene, arylene, heteroarylene, —C(O)—R₂—, and —C(O)—R₂—C(O)—; and
wherein R₂ is independently selected from the group consisting of substituted or unsubstituted alkylene, alkenylene, arylene, and heteroarylene;
wherein R₃ is independently selected from O or S; and wherein
the cation is a quaternary ammonium or phosphonium cation;
wherein the process comprises:
(1) contacting boric acid, phosphoric acid or a mixture thereof with a metal hydroxide and H—R₃—R₁—OH under conditions sufficient to form a metal salt comprising an anion having the structure 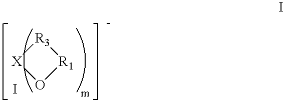
wherein X, R1, and R3 are as previously described; and
(2) contacting the metal salt with Q-X; wherein Q is a quaternary ammonium or phosphonium ion and X is a halide, to form an ionic liquid, or solvate or hydrate thereof.

32. The process of claim 31 which further comprises separating the ionic liquid, hydrate, or solvate thereof from any by-products.

33. The process of claim 32 wherein separating comprises adding a solvent to extract the ionic liquid.

34. The process of claim 33 wherein the solvent comprises alkyl chloride.
